(19) United States
(12) Patent Application Publication
(10) Pub. No.: US 2024/0022308 A1
(43) Pub. Date: Jan. 18, 2024

(54) Selecting One or More Beams for Communication and/or Measurement, or Determining Motion of a Wireless Device

(71) Applicant: Telefonaktiebolaget LM Ericsson (publ), Stockholm (SE)

(72) Inventors: Ashkan Kalantari, Malmö (SE); Saeed Bastani, Dalby (SE); Bhavin Patel, Malmö (SE); Mohammed Zourob, London (CA)

(21) Appl. No.: 18/037,180

(22) PCT Filed: Nov. 19, 2020
(86) PCT No.: PCT/EP2020/082770

§ 371 Date: May 16, 2023

(51) Int. Cl. H04B 7/06; G01S 5/00; H04B 7/08; H04W 64/00

(52) U.S. Cl. CPC H04B 7/0695; G01S 5/0027; G01S 5/01; H04B 7/088; H04W 64/006

(57) ABSTRACT

Methods and apparatus are provided. In an example aspect, a method in a network node of selecting one or more beams for communication with a wireless device and/or measurement by the wireless device is provided. The method comprises determining an indication of a location of a wireless device, determining an indication of motion of the wireless device, determining probabilities that the wireless device will move along each of a plurality of routes based on the indication of location of the wireless device and the indication of motion of the wireless device, and selecting one or more beams served by a base station for communication with the wireless device and/or measurement by the wireless device based on the probabilities.

### TECHNICAL FIELD

Examples of the present disclosure relate to selecting one or more beams for communication and/or measurement, for example based on indications of location and motion of the wireless device. Examples of the present disclosure also relate to determining motion of a wireless device.

### BACKGROUND

Beamforming or spatial filtering is a signal processing technique used in sensor arrays for directional signal transmission or reception. This is achieved by combining elements in an antenna array in such a way that signals at particular angles experience constructive interference while others experience destructive interference. Beamforming implies transmitting signals from multiple antenna elements of an antenna array with an amplitude and/or phase shift applied to the signal for each antenna elements. These amplitude/phase shifts are commonly denoted as the antenna weights and the collection of the antenna weights for each of the antennas is a precoding vector or matrix. Different precoding vectors for the different antennas gives rise to beamforming of the transmitted signal, and the weights can be controlled so that the signals experience constructive interference in certain direction(s), in which case it is said that a beam is formed in that direction or those directions.

Traditional beam training algorithms perform hierarchical exhaustive search to find the best transmit and receive beams on each device. For example, a wireless device such as a User Equipment may perform measurements on signals corresponding to multiple beams transmitted from a base station to allow the base station to select the best beam for communicating with the wireless device.

### SUMMARY

One aspect of the present disclosure provides a method in a network node of selecting one or more beams for communication with a wireless device and/or measurement by the wireless device. The method comprises determining an indication of a location of a wireless device, determining an indication of motion of the wireless device, and determining probabilities that the wireless device will move along each of a plurality of routes based on the indication of location of the wireless device and the indication of motion of the wireless device. The method also comprises selecting one or more beams served by a base station for communication with the wireless device and/or measurement by the wireless device based on the probabilities.

Another aspect of the present disclosure provides a method in a wireless device. The method comprises determining a proximity of the wireless device to a junction of two or more of a plurality of routes based on a location of the wireless device. The method also comprises determining motion of the wireless device from one or more sensors of the wireless device at a first rate based on the proximity, determining a location of the wireless device at a second rate based on the proximity, and/or reporting an indication of the motion and/or location of the wireless device to the network node at a third rate based on the proximity.

A further aspect of the present disclosure provides a network node comprising an apparatus for selecting one or more beams for communication with a wireless device and/or measurement by the wireless device. The apparatus comprises a processor and a memory. The memory contains instructions executable by the processor such that the apparatus is operable to determine an indication of a location of a wireless device, determine an indication of motion of the wireless device, determine probabilities that the wireless device will move along each of a plurality of routes based on the indication of location of the wireless device and the indication of motion of the wireless device, and select one or more beams served by a base station for communication with the wireless device and/or measurement by the wireless device based on the probabilities.

A still further aspect of the present disclosure provides a wireless device comprising an apparatus. The apparatus comprises a processor and a memory. The memory contains instructions executable by the processor such that the apparatus is operable to determine a proximity of the wireless device to a junction of two or more of a plurality of routes based on a location of the wireless device; and determine motion of the wireless device from one or more sensors of the wireless device at a first rate based on the proximity, determining a location of the wireless device at a second rate based on the proximity, and/or reporting an indication of the motion and/or location of the wireless device to the network node at a third rate based on the proximity.

An additional aspect of the present disclosure provides a network node comprising an apparatus for selecting one or more beams for communication with a wireless device and/or measurement by the wireless device. The apparatus is configured to determine an indication of a location of a wireless device, determine an indication of motion of the wireless device, determine probabilities that the wireless device will move along each of a plurality of routes based on the indication of location of the wireless device and the indication of motion of the wireless device, select one or more beams served by a base station for communication with the wireless device and/or measurement by the wireless device based on the probabilities.

Another aspect of the present disclosure provides a wireless device comprising an apparatus. The apparatus is configured to determine a proximity of the wireless device to a junction of two or more of a plurality of routes based on a location of the wireless device, and determine motion of the wireless device from one or more sensors of the wireless device at a first rate based on the proximity, determining a location of the wireless device at a second rate based on the proximity, and/or reporting an indication of the motion and/or location of the wireless device to the network node at a third rate based on the proximity.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method in a network node of selecting one or more beams for communication with a wireless device and/or measurement by the wireless device;

FIG. 2 is a flow chart of an example of a method in a wireless device;

FIG. 3 illustrates an example of a scenario in which embodiments of this disclosure may be used;

FIG. 4 is a schematic of an example of an apparatus for selecting one or more beams for communication with a wireless device and/or measurement by the wireless device according to an example of this disclosure;

FIG. 5 is a schematic of an example of an apparatus according to an example of this disclosure;

FIG. 6 is a flow chart of an example of a method according to the present disclosure; and

FIG. 7 is a flow chart of another example of a method according to the present disclosure.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Beam training and assignment currently use exhaustive search methods that consider every beam and may require significant time. When a wireless device moves location or the environmental conditions change, the beam selection procedure needs to be repeated, which further increases the time and overhead. Therefore, methods and apparatus that aim to reduce the number of beams considered (e.g. reduce the number of beams for which measurements are performed by a wireless device) may be advantageous.

For example, embodiments of this disclosure may consider a route that is taken by a wireless device to determine beams for measurement or communication. More specifically, for example, methods and apparatus may consider location and motion of a wireless device to determine respective probabilities that the wireless device will move along a plurality of routes (e.g. roads, footpaths and the like), and this information may then be used to select one or more beams for measurement and/or communication. For example, if the wireless device is most likely to travel along a particular route based on the location and motion, the selected beams may be those that are known to serve that particular route, and other beams (e.g. those with poor signal strength along that particular route) may be excluded.

WO2018/054498 discloses a radio network node that determines that a wireless device is onboard a public transit vehicle. Based on that determination, the radio network node predicts a position of the public transit vehicle and to control beamforming for the wireless device based on the predicted position. However, this document does not disclose considering location and motion of the wireless device to determine probabilities that the wireless device will move along a plurality of routes. Furthermore, this document does not take into account motion such as acceleration or change of direction of the wireless device when determining probabilities that the wireless device will move along particular routes, such as for example when approaching a junction of a plurality of routes.

A network node such as for example a Radio Base Station (RBS) may use a plurality of routes such as a digital map, location information of one or more wireless devices, and motion information of the wireless device(s) to reduce the beam selection search space and time for the wireless device(s). The motion information, which may be for example information from the an inertial motion unit (IMU) of the wireless device, may for example be used to predict a possible future route of the device and can be useful to estimate the route selection likelihood when the wireless device approaches a junction of multiple routes. Therefore, in some examples, the network node may combine the motion information with the location of the wireless device and known routes to calculate the route selection likelihood of the wireless device more accurately. For example, the network node may calculate the probability that the wireless device will move along each of a plurality of routes based on the location and motion information for the wireless device. In some examples, an accurate location of the UE is not required since the location may be used to determine whether the wireless device is near or approaching a junction or another route, and an approximate location may be sufficient.

Reducing the beam search space may in some examples reduce the overhead for beam searching by wireless devices, and may allow the network node to serve more wireless devices and/or serve wireless devices at a higher data rate. Reading motion information from an IMU in a wireless device and sending it to the network node may in some examples be costly, since the wireless device consumes power to read the output of the IMU sensor and transmit this information to the network node. Thus, in some examples, the network node may adaptively request or instruct the reporting of the location and/or motion information, and in some examples also channel state information (CSI), from the wireless device. For example, when UE moves on a straight route and is far from a junction, e.g., crossroad or route exit, the network node may request reporting of location and/or motion information at a lower rate compared to the case where the wireless device is close to a junction. This adaptive rate may in some examples save power at the wireless device, which in some circumstances may read data from an IMU at a lower rate and/or send information to the network node at a lower rate. On the other hand, the increased rate in some circumstances (e.g. close to a junction) may allow the network node to estimate the route selection likelihood, e.g. the probability that the wireless device will move along a particular route, more accurately than if a lower rate was used.

The network node may in some examples use the probability that the wireless device will move along each of a plurality of routes to train a specific subset of beams and assign the beams to the wireless before it moves out of coverage of a beam currently serving the wireless device. Some beams may have better coverage if the wireless device moves along a specific route, for example after a junction. In a particular example, location and motion information of a wireless device may indicate that the wireless device is approaching a junction and is slowing down and/or turning. The motion information may indicate the decrease in wireless device speed/velocity and perhaps the direction of turning. Therefore, the network node may determine that the wireless device is more likely to move along a particular route than another, for example the route towards which the wireless device is turning, and thus allocate an appropriate subset of beams to the wireless device in advance, and avoids unnecessary beam training through all available beams.

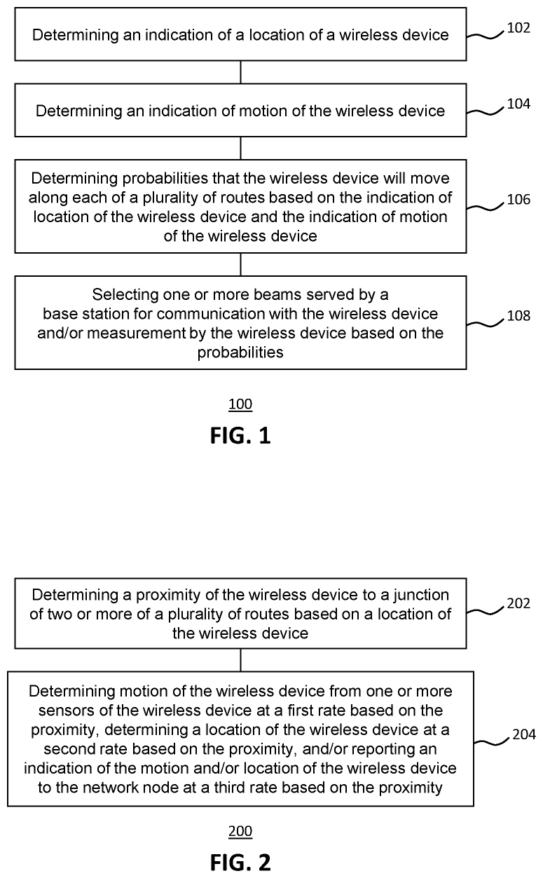

FIG. 1 is a flow chart of an example of a method 100 in a network node of selecting one or more beams for communication with a wireless device and/or measurement by the wireless device. The network node may be for example a base station or any other suitable network node. The method 100 comprises, in step 102, determining an indication of a location of a wireless device. This may be done in any of a number of suitable ways. For example, the indication of the location may be received from the wireless device at the network node, or may be determined by the network node from information received from one or more network nodes (including for example receiving an indication of the location of the wireless device from a location server).

Step 104 of the method 100 comprises determining an indication of motion of the wireless device. In some examples, the indication of motion of the wireless device may indicate one or more of a velocity of the wireless device, a direction of the wireless device, a change in location of the wireless device, a change in speed of the wireless device, a speed of the wireless device and data from an inertial motion unit (IMU) of the wireless device. Thus for example the indication of motion may be received from the wireless device or another network node, or may be determined based on data from the wireless device and/or one or more other network nodes. In some examples, the motion may be determined based on the location of the wireless device, and in particular change in location over a period of time. This may be used to determine any suitable parameter for the motion, such as e.g. acceleration/deceleration, change in velocity or direction, direction of acceleration/deceleration etc.

The method 100 also comprises, in step 106, determining probabilities that the wireless device will move along each of a plurality of routes based on the indication of location of the wireless device and the indication of motion of the wireless device. The plurality of routes may comprise, for example, a digital map or otherwise a collection or database of routes comprising for example roads, footpaths and any other routes that the wireless device may move along, for example while the device is moving or travelling. For example, this may comprise respective probability that the wireless device will move along each of the plurality of routes based on the indication of location and the indication of motion of the wireless device. In some examples, probabilities may be determined only for those routes that meet one or more criteria, e.g. routes that are within a predetermined distance of the wireless device's location, routes that the device is permitted to move along (e.g. the device may not be permitted to move along a bus route if it is in a car, or an unpermitted direction along a one-way street) and/or routes that are connected to the route that the wireless device is currently on (e.g. each of the routes are connected to the current route by a junction).

The probabilities may be determined based on the location and motion in some examples in any suitable manner. For example, if the wireless device is approaching a junction and changes speed (e.g. slows down) or turns as indicated by the indication of motion, this may suggest that the user of the wireless device is preparing to make a turn at the junction and move along a particular route of a plurality of routes available from that junction. Thus the probability for that particular route may be higher than the probabilities for other routes from that junction.

Step 108 of the method comprises selecting one or more beams served by a base station for communication with the wireless device and/or measurement by the wireless device based on the probabilities. For example, the network node may select those beams that are known to be available and have good signal strength along the one or more routes with the highest probabilities, and exclude or deselect beams that are known to be unavailable or have poor signal strength along the one or more routes. Thus for example one or more beams that are available and have good signal strength along one or more routes with the lowest probabilities may be excluded, for example, if the beam(s) are unavailable or have poor signal strength along the one or more routes with the highest probabilities. In some examples, a route may be within a particular geographical area that is encompassed by or traverses a particular geographical area of certain beams. Therefore, for example, knowledge of the probabilities that the wireless device will move along particular routes may be used to determine probabilities (or may suggest) that the wireless device will be best served by those particular beams, for example, or may be used to select those beams for communication and/or measurement.

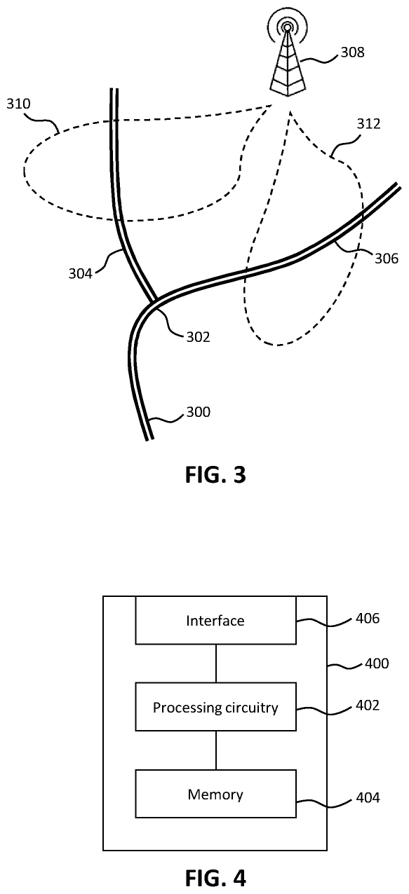

FIG. 3 illustrates an example of a scenario in which embodiments of this disclosure may be used. For example, a wireless device may be moving along a route 300, such as for example a road, towards a junction 302. The wireless device may at the junction 302 subsequently move along a first route 304 or a second route 306. According to embodiments of this disclosure, a network node (such as for example a base station 308 or another network node such as for example a node in a core network) may determine a first probability that the wireless device will move along the first route 304 after the junction 302, and a second probability that the wireless device will instead move along the second route 306. The probabilities may be determined based on any appropriate factor(s) including for example the wireless device's location and motion. For example, the junction 302 may be a road junction whereby a vehicle may continue straight ahead to move along the second route 306, and turn left to move along the first route 304. The wireless device's motion for example may indicate that the wireless device is slowing down or turning to move onto the first route 304, and thus the first probability may be determined to be higher than the second probability. Alternatively, for example, the wireless device may not slow down or turn when approaching the junction 302, which may suggest that the wireless device will continue straight ahead onto the second route 306. Hence, the second probability may be higher than the first probability.

The base station 308 may provide a first beam with a first coverage area 310 that covers the first route 304 (or a part thereof), but does not cover the second route 306, and a second beam with a second coverage area 312 that covers the second route 306 (or a part thereof), but does not cover the first route 304. In some examples, if the first probability is higher than the second probability, the network node may select the first beam and not the second beam for communication and/or measurement (e.g. beam training) by the wireless device.

Alternatively, in some examples, if the second probability is higher than the first probability, the network node may select the second beam and not the first beam for communication and/or measurement (e.g. beam training) by the wireless device.

Advantages of examples of this disclosure may include one or more of the following:
1) Reduces the beam selection time for a wireless device by selecting a subset of beams for the wireless device instead of searching through a larger set of beams (e.g. all beams served by the network node).
2) Reduces the beam space to achieve faster beam training by the wireless device and network
3) Performs beam selection and assignment without depending on historical data and training, though this can be an optional feature.
4) Saves power at the network node or base station by selecting a subset of beams.
5) Saves power at wireless device, since the wireless device may receive better coverage from the base station and/or may use less energy for communication.
6) Reduces the number of channel state information (CSI) measurements, and thus may improve spectrum efficiency and consequently average cell throughput.

Step 108 may in some examples comprise selecting one or more beams served by a base station for measurement by the wireless device based on the probabilities. In such examples, the method 100 may further comprise sending an indication of the selected one or more beams to the wireless device, such that the wireless device becomes aware of the beam(s) that are to be measured. The wireless device may then for example skip measurement of other beams, e.g. from the point at which the indication of the selected beam(s) is received or when the wireless device begins moving along one of the route(s) with the highest probabilities, thus reducing the amount of time taken by the wireless device and overhead for beam training and measurement in some examples.

In some examples, the network node may determine a route with the highest probability in step 106. Therefore, for example, in step 108 the network node may select those one or more beams that are known to be optimal for communicating with wireless devices along at particular route.

Selecting one or more beams served by a base station for communication with the wireless device and/or measurement by the wireless device based on the probabilities in step 108 may comprise in some examples selecting a subset of beams served by the base station based on the probabilities. Thus for example the wireless device may perform measurements on only the subset of beams rather than all beams available or served by the network node or a particular base station, and thus may reduce beam training time and/or network signaling for example.

In some examples, selecting one or more beams served by a base station for communication with the wireless device and/or measurement by the wireless device based on the probabilities in step 108 comprises selecting one or more beams served by a base station for measurement by the wireless device based on the probabilities. The method may then for example further comprise sending an indication of the selected one or more beams to the wireless device. Thus the wireless device may receive knowledge of those selected beams and may thus communicate and/or perform measurements using the selected beams accordingly.

In some examples, the method 100 comprises determining a proximity of the wireless device to a junction of two or more of the routes based on the indication of the location of the wireless device. The method 100 may then comprise for example sending an instruction to the wireless device to obtain the indication of motion of the wireless device from one or more sensors of the wireless device at a first rate based on the proximity, and/or report the indication of motion of the wireless device to the network node at a second rate based on the proximity, and/or report the indication of the location of the wireless device to the network node at a third rate based on the proximity. For example, if the wireless device is near or is approaching a junction of two or more routes, it may be more likely to change direction or move onto a different route than if the wireless device is not near or is not moving towards a junction. Hence, for example, an increased rate of motion and/or location measurement and/or reporting may allow the network node to determine the location and/or motion more accurately and/or determine a better indication of the motion of the wireless device over time, which may then improve the probability determination in step 106 compared to if the rate increase is not implemented. Thus, for example, the first rate, the second rate and/or the third rate may be higher for a shorter proximity.

As an optional step, in some examples, the network node can process received RF signals and/or collect weather information to be aware of the rain condition in the environment around the wireless device. This may be used along with the calculated route selection likelihood of the users for better beam allocation. For example, weather information may be used together with historical information relating to the availability or signal strength of particular beams (e.g. as reported by wireless devices) to determine that particular beams do not perform as well in certain regions than other beams when it is raining. The weather information can thus be used for example to exclude those particular beams from communication and/or measurement by the wireless device when it is determined that the wireless device is most likely to move along a route that traverses that region. Additionally or alternatively, for example, certain radio frequencies may be more affected by rain than other frequencies, such as higher frequencies. In some examples, therefore, higher frequency beams may be excluded from communication and/or measurement when it is raining.

As another optional step, the network node may maintain a statistical table using the historical radio link failures, travel direction, route taken, and/or orientation of the wireless device to improve future beam selection. In a particular example, methods as described herein may be used for handover if the UE is near the boundary of a cells. In other words, for example, another network node or base station can be pre-prepared to provide the best set of beams for the wireless device if it is moving towards a cell served by the other base station.

In some examples, determining the indication of the location of the wireless device in step 102 of the method 100 comprises receiving the indication of the location of the wireless device from the wireless device. Thus the wireless device may include a sensor (e.g. a GPS sensor) or other means for determining its location. Additionally or alternatively, determining the indication of motion of the wireless device in step 104 comprises receiving the indication of motion of the wireless device from the wireless device. Thus for example the wireless device may include an inertial motion unit (IMU) or other means for determining its motion.

Selecting one or more beams served by a base station for communication with the wireless device and/or measurement by the wireless device based on the probabilities in step 108 may in some examples comprise selecting a wide beam and at least one narrow beam within the wide beam. In a particular example, the wireless device may be at or moving towards the edge of a currently serving wide beam, and the network node may use the determined probabilities (e.g. determined in step 106 above) to select (e.g. in step 108 above) the next beam sector (e.g. wide beam) and the corresponding narrow beams. The network node and wireless device may then train a subset of one or more wide beams and then a subset of narrow beams within the selected wide beam(s), e.g. at points where the wireless device moves or is predicted to move from one wide beam to another.

FIG. 2 is a flow chart of an example of a method 200 in a wireless device. The method comprises, in step 202, determining a proximity of the wireless device to a junction of two or more of a plurality of routes based on a location of the wireless device. The method 200 also comprises, in step 204, determining motion of the wireless device from one or more sensors of the wireless device at a first rate based on the proximity, determining a location of the wireless device at a second rate based on the proximity, and/or reporting an indication of the motion and/or location of the wireless device to a network node at a third rate based on the proximity. Thus, for example, the wireless device may determine the location and/or motion, and/or report the location and/or motion, at a higher rate if the wireless device is nearer to the junction. As suggested above, this may in some examples may lead to a more accurate determination of the location and/or motion of the wireless device by the wireless device or the network node (e.g. base station), and/or may lead to better determination of the probabilities referred to above with reference to the method 100 of FIG. 1. In some examples, the first rate, the second rate and/or the third rate is higher for a shorter proximity.

FIG. 4 is a schematic of an example of an apparatus 400 (e.g. comprised in a network node) for selecting one or more beams for communication with a wireless device and/or measurement by the wireless device. The apparatus 400 comprises processing circuitry 402 (e.g. one or more processors) and a memory 404 in communication with the processing circuitry 402. The memory 404 contains instructions executable by the processing circuitry 402. The apparatus 400 also comprises an interface 406 in communication with the processing circuitry 402. Although the interface 406, processing circuitry 402 and memory 404 are shown connected in series, these may alternatively be interconnected in any other way, for example via a bus.

In one embodiment, the memory 404 contains instructions executable by the processing circuitry 402 such that the apparatus 400 is operable to determine an indication of a location of a wireless device, determine an indication of motion of the wireless device, determine probabilities that the wireless device will move along each of a plurality of routes based on the indication of location of the wireless device and the indication of motion of the wireless device, and select one or more beams served by a base station for communication with the wireless device and/or measurement by the wireless device based on the probabilities. In some examples, the apparatus 400 is operable to carry out the method 100 described above with reference to FIG. 1.

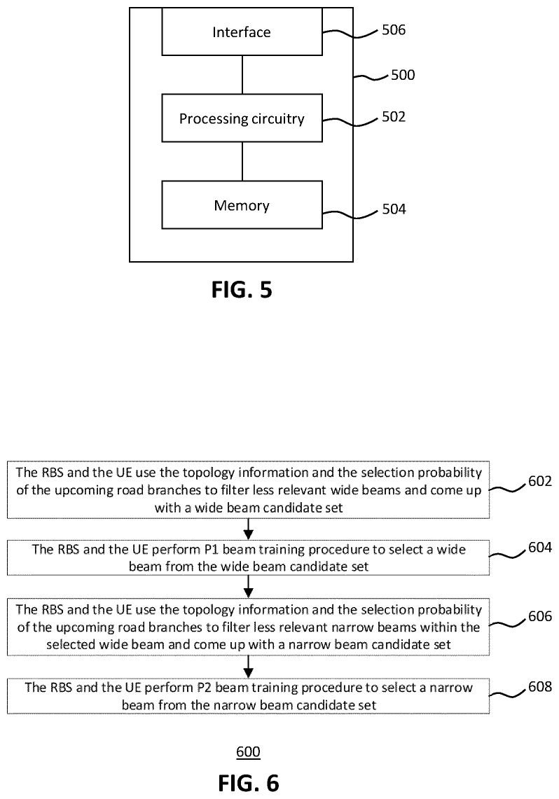

FIG. 5 is a schematic of an example of an apparatus 500 (e.g. comprised in a wireless device). The apparatus 500 comprises processing circuitry 502 (e.g. one or more processors) and a memory 504 in communication with the processing circuitry 502. The memory 504 contains instructions executable by the processing circuitry 502. The apparatus 500 also comprises an interface 506 in communication with the processing circuitry 502. Although the interface 506, processing circuitry 502 and memory 504 are shown connected in series, these may alternatively be interconnected in any other way, for example via a bus.

In one embodiment, the memory 504 contains instructions executable by the processing circuitry 502 such that the apparatus 500 is operable to determine a proximity of the wireless device to a junction of two or more of a plurality of routes based on a location of the wireless device, and determine motion of the wireless device from one or more sensors of the wireless device at a first rate based on the proximity, determining a location of the wireless device at a second rate based on the proximity, and/or reporting an indication of the motion and/or location of the wireless device to the network node at a third rate based on the proximity. In some examples, the apparatus 500 is operable to carry out the method 200 described above with reference to FIG. 2.

FIG. 6 is a flow chart of an example of a method 600 according to the present disclosure. Step 602 of the method 600 comprises the Radio Base Station, RBS (or network node in other examples) and the User Equipment, UE (or wireless device in other examples) using topology information (optional) of the geographical area around the UE and/or between the RBS and the UE, and using the one or more selection probabilities (e.g. as determined in step 106 of the method 100 described above) of upcoming road branches, which may be for example possible routes that the UE may move along, to filter less relevant wide beams and come up with a wide beam candidate set of one or more wide beams. Thus the step 602 may be an example implementation of the step 108 of the method 100 in some examples. Step 604 of the method 600 comprises the RBS and UE performing a P1 beam training procedure to select a wide beam from the wide beam candidate set.

Step 606 of the method 600 comprises The RBS and UE using topology information (optional) of the geographical area around the UE and/or between the RBS and the UE, and using the one or more selection probabilities (e.g. as determined in step 106 of the method 100 described above) of upcoming road branches, to filter less relevant narrow beams (e.g. within the beam selected in step 604) and come up with a wide beam candidate set of one or more narrow beams. Step 608 comprises the RBS and UE performing a P2 beam training procedure to select a narrow beam from the narrow beam candidate set.

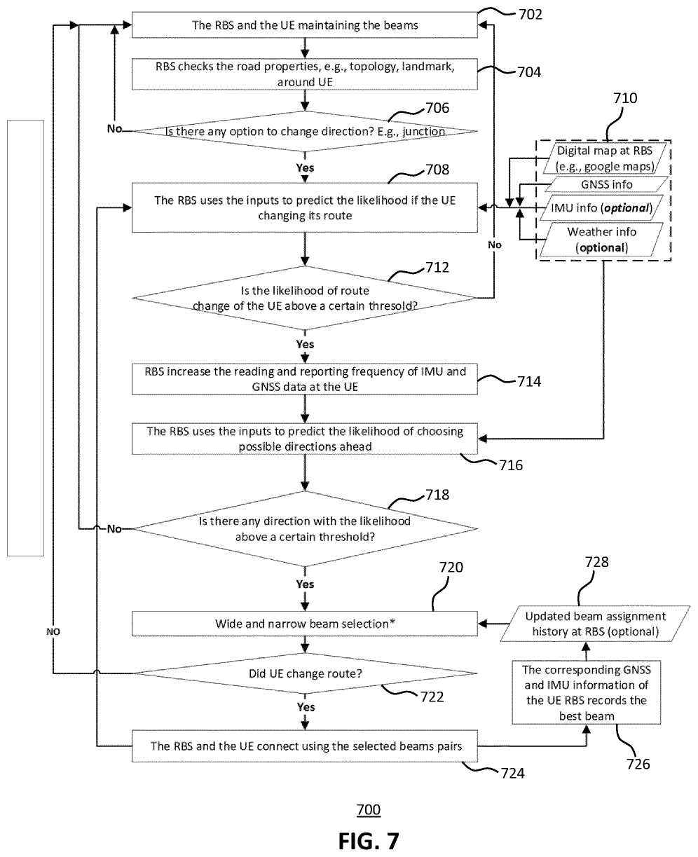

FIG. 7 is a flow chart of another example of a method 700 according to the present disclosure. For example, the method 700 may be a method in a network node of selecting one or more beams for communication with a wireless device and/or measurement by the wireless device. The network node may be for example a base station or any other suitable network node. Step 702 of the method 700 comprises the RBS (radio base station, which may be the network node in some examples) maintaining the beams that are currently used for communication between the RBS and a wireless device such as a User Equipment (UE). In step 704, the RBS checks the road properties around the UE, such as for example the topology of the terrain and any landmarks—in some examples, this information may be used to exclude certain beams from communication/measurement if the road properties around the UE block or otherwise affect these beams.

In step 708, the RBS uses inputs 710 (and also information from step 706, if any) to predict the likelihood of the UE changing its route. The inputs 710 may comprise, for example, one or more of a digital map (e.g. collection of routes), Global Navigation Satellite System (GNSS) info indicating the location of the UE, optionally Inertial Motion Unit (IMU) info from the UE, and optionally weather information. In step 712, it is determined whether the likelihood of a route change by the UE (e.g. taking a different route than the UE is currently moving along) determined in step 712 is above a certain threshold. If not, the method 700 returns to step 702. If so, the method proceeds to step 714, where the RBS increases the reading and reporting frequency (or rate) of IMU and GNSS data by the UE (e.g. by sending an instruction to the UE).

In step 716, the RBS uses the inputs 710 to predict the likelihood of the UE moving along particular routes ahead of the UE in the direction that the UE is moving, e.g. routes connected to a junction towards which the UE is moving. For example, a respective probability may be determined that the UE will move along each of the routes based on the inputs 710. In step 718, it is determined whether there are any routes (or directions) with a probability or likelihood above a certain threshold, which may or may not be the same as the threshold in step 712. If there are no such routes, the method 700 returns to step 702, otherwise the method proceeds to step 720.

In step 720, wide and narrow beams are selected, for example wide and narrow beams that are known to have good signal strength or favourable other properties along the route(s) with probabilities higher than the threshold as determined in step 718. The method 600 shown in FIG. 6 may be an example of step 720 in some examples. In step 722, it is determined whether the UE changed its route, e.g. if it started to move along a route with a probability above the threshold as determined in step 718. If not, the method 700 returns to step 702, otherwise the method proceeds to step 724, where the RBS and UE connect using the selected beam or beam pair (e.g. a wide and narrow beam as selected in steps 604 and 608 of the method 600 of FIG. 6). Next, the method 700 returns to step 708. Alternatively, in some examples, the method proceeds from step 724 to step 726, where the RBS records the selected or ‘best’ beam(s) corresponding to the GNSS and IMU information from the UE, for example to ensure that another UE with similar GNSS and IMU information (and/or e.g. a similar probability of moving along the same route) may in the future be assigned the same beams for communication and/or measurement. In optional step 728, the RBS may thus update beam assignment history at the RBS. The method 700 then returns to step 720.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1-31. (canceled)

32. A method in a network node of selecting one or more beams for communication with a wireless device and/or measurement by the wireless device, the method comprising:
determining an indication of a location of a wireless device;
determining an indication of motion of the wireless device;
determining probabilities that the wireless device will move along each of a plurality of routes based on the indication of location of the wireless device and the indication of motion of the wireless device; and
selecting one or more beams served by a base station for communication with the wireless device and/or measurement by the wireless device based on the probabilities.

33. The method of claim 32, wherein determining probabilities that the wireless device will move along each of a plurality of routes based on the indication of location and the indication of motion of the wireless device comprises determining a respective probability that the wireless device will move along each of the plurality of routes based on the indication of location and the indication of motion of the wireless device.

34. The method of claim 32, wherein the indication of motion of the wireless device comprises one or more of a velocity of the wireless device, a direction of the wireless device, a change in location of the wireless device, a change in speed of the wireless device, a speed of the wireless device and data from an inertial motion unit (IMU) of the wireless device.

35. The method of claim 32, wherein selecting one or more beams served by a base station for communication with the wireless device and/or measurement by the wireless device based on the probabilities comprises selecting a subset of beams served by the base station based on the probabilities.

36. The method of claim 32, wherein selecting one or more beams served by a base station for communication with the wireless device and/or measurement by the wireless device based on the probabilities comprises selecting one or more beams served by a base station for measurement by the wireless device based on the probabilities, and the method further comprises sending an indication of the selected one or more beams to the wireless device.

37. The method of claim 32, further comprising:
determining a proximity of the wireless device to a junction of two or more of the routes based on the indication of the location of the wireless device; and
sending an instruction to the wireless device to:
obtain the indication of motion of the wireless device from one or more sensors of the wireless device at a first rate based on the proximity; and/or
report the indication of motion of the wireless device to the network node at a second rate based on the proximity; and/or
report the indication of the location of the wireless device to the network node at a third rate based on the proximity.

38. The method of claim 37, wherein the first rate, the second rate, and/or the third rate is higher for a shorter proximity.

39. The method of claim 32, wherein:
determining the indication of the location of the wireless device comprises receiving the indication of the location of the wireless device from the wireless device; and/or
determining the indication of motion of the wireless device comprises receiving the indication of motion of the wireless device from the wireless device.

40. The method of claim 32, wherein selecting one or more beams served by a base station for communication with the wireless device and/or measurement by the wireless device based on the probabilities comprises selecting a wide beam and at least one narrow beam within the wide beam.

41. A method, implemented by a wireless device, the method comprising:
determining a proximity of the wireless device to a junction of two or more of a plurality of routes based on a location of the wireless device; and
determining motion of the wireless device from one or more sensors of the wireless device at a first rate based on the proximity, determining a location of the wireless device at a second rate based on the proximity, and/or reporting an indication of the motion and/or location of the wireless device to a network node at a third rate based on the proximity.

42. The method of claim 41, wherein the first rate, the second rate and/or the third rate is higher for a shorter proximity.

43. A network node comprising:
processing circuitry and a memory, the memory containing instructions executable by the processing circuitry such that the processing circuitry is configured to:
determine an indication of a location of a wireless device;
determine an indication of motion of the wireless device;
determine probabilities that the wireless device will move along each of a plurality of routes based on the indication of location of the wireless device and the indication of motion of the wireless device; and
select one or more beams served by a base station for communication with the wireless device and/or measurement by the wireless device based on the probabilities.

44. The network node of claim 43, wherein the processing circuitry is further configured to determine probabilities that the wireless device will move along each of a plurality of routes based on the indication of location and the indication of motion of the wireless device by determining a respective probability that the wireless device will move along each of the plurality of routes based on the indication of location and the indication of motion of the wireless device.

45. The network node of claim 43, wherein the indication of motion of the wireless device comprises one or more of a velocity of the wireless device, a direction of the wireless device, a change in location of the wireless device, a change in speed of the wireless device, a speed of the wireless device and data from an inertial motion unit (IMU) of the wireless device.

46. The network node of claim 43, wherein the processing circuitry is further configured to select one or more beams served by a base station for communication with the wireless device and/or measurement by the wireless device based on the probabilities by selecting a subset of beams served by the base station based on the probabilities.

47. The network node of claim 43, wherein the processing circuitry is further configured to select one or more beams served by a base station for communication with the wireless device and/or measurement by the wireless device based on the probabilities by selecting one or more beams served by a base station for measurement by the wireless device based on the probabilities, and send an indication of the selected one or more beams to the wireless device.

48. The network node of claim 43, wherein the processing circuitry is further configured to:
determine a proximity of the wireless device to a junction of two or more of the routes based on the indication of the location of the wireless device; and
send an instruction to the wireless device to obtain the indication of motion of the wireless device from one or more sensors of the wireless device at a first rate based on the proximity, and/or report the indication of motion of the wireless device to the network node at a second rate based on the proximity, and/or report the indication of the location of the wireless device to the network node at a third rate based on the proximity.

49. The network node of claim 43, wherein the processing circuitry is further configured to:
determine the indication of the location of the wireless device by receiving the indication of the location of the wireless device from the wireless device; and/or
determine the indication of motion of the wireless device by receiving the indication of motion of the wireless device from the wireless device.

50. The network node of claim 43, wherein the processing circuitry is further configured to select one or more beams served by a base station for communication with the wireless device and/or measurement by the wireless device based on the probabilities by selecting a wide beam and at least one narrow beam within the wide beam.

51. A wireless device comprising:
processing circuitry and a memory, the memory containing instructions executable by the processing circuitry such that the processing circuitry is configured to:
determine a proximity of the wireless device to a junction of two or more of a plurality of routes based on a location of the wireless device; and
determine motion of the wireless device from one or more sensors of the wireless device at a first rate based on the proximity, determining a location of the wireless device at a second rate based on the proximity, and/or reporting an indication of the motion and/or location of the wireless device to a network node at a third rate based on the proximity.
